(19) United States
(12) Patent Application Publication
(10) Pub. No.: US 2005/0017527 A1
(43) Pub. Date: Jan. 27, 2005

(54) Hook

(76) Inventor: Reinhard Smetz, Baldingen (DE)

Correspondence Address: Mark P Stone, 4th Floor, 25 Third Street, Stamford, CT, 06905, US

(21) Appl. No.: 10/498,970

(22) PCT Filed: Dec. 18, 2002
(86) PCT No.: PCT/DE02/04691

(30) Foreign Application Priority Data
Dec. 21, 2001 (DE) 101 64 595.3

(51) Int. Cl. B66C 1/34

(52) U.S. Cl. 294/82.1

(57) ABSTRACT

Disclosed is a hook comprising a fork head (10) suitable to be connected to a high-strength round steel chain. A ring-shaped eye (14) is disposed next to the insertion slot (7) of the fork head (10), which is bridged by a cross bolt. The width (W₂) of said eye (14) is larger than the width (W₁) of the fork head's (10) insertion slot (7).

### TECHNICAL FIELD

The invention relates to a hook with a fork head which is suitable for connecting a high-strength round steel chain and of which the fork tines bound an introduction gap, of which the width is equal to 1.05 to 1.3 times the thickness of the links of the round steel chain and which is spanned by a cross-bolt adapted to the inner width of the chain link which is to be connected in each case.

Hooks of the abovementioned type are used as attachment means which regularly form constituent parts of modular-constriction attachment systems with components which cannot be mixed up.

Prior Art

DE 8429724.7 U1 discloses a hook of the generic type of which the fork head has two rectilinear fork tines arranged parallel to one another. The facing sides of the fork tines bound an introduction gap or an introduction slot, of which the width is sufficiently large in order to accommodate the end link of a chain strand which has its strength coordinated with the strength of the hook. The combination of an excessively strong hook with the end link of a chain of low strength here is ensured by virtue of the thickness of the cross-bolt which spans the introduction gap being coordinated with the inner width of the end link of the respective chain strand, suitable graduations in the nominal thickness of the chains of systems which cannot be mixed up taking account of tolerances of the components which are to be combined. For cases where small graduations of the system components are important, it is known, from DE 3045209 C2, for the likewise essentially U-shaped introduction gap of a fork head to be defined in a step-like manner such that its width decreases in the direction of the base of the introduction gap.

### DESCRIPTION OF THE INVENTION

The known hooks are not fully satisfactory in so far as they are merely suitable for connecting to the end link of a chain strand. The object of the invention is to provide a hook to which other components of attachment systems can also be connected. This object is achieved according to the invention in that the fork tines of the hook in question, outside the region of the introduction gap, form an annular eye, of which the inside width is greater than the width of the introduction gap.

The hook according to the invention provides the advantage that, in addition to end links of chain strands, it is possible to fit into its fork head, inter alia, suspension members, connecting members, eye hooks and shortening elements which are provided with a connection eye and, in a known manner, have flattened portions which allow them to be connected to connecting members which are designed in the manner of omega shackles with an introduction gap coordinated to the dimensions of chain links in a similar manner to the introduction gap of known fork-head hooks. It is thus possible, in contrast to known fork-head hooks, for a hook according to the invention which can be fitted into an eye of a point of attachment fastened on a load to be connected directly, without the interposition of a short chain-strand section and of a connecting member, to a suspension member for a crane hook, of which the dimensions, as is known, are usually considerably greater than hooks of the type according to the invention, which form constituent parts of an attachment system. If a ring bolt with a flattened portion is used as the point of attachment, it is also possible for the hook to be connected directly to the ring bolt and to be fitted into a suspension member designed as an end link of a suspension gear mechanism.

Further features and details of the invention can be gathered from the subclaims and from the following description of two particularly advantageous embodiments of the invention which are illustrated in the attached drawing.

### BRIEF DESCRIPTION OF THE DRAWINGS

In the drawings:

FIG. 1 shows the rear view of a hook which is connected directly to a suspension member which is illustrated in side view and into which a crane hook can be fitted;

FIG. 2 shows the side view of the hook according to FIG. 1 connected to the sectionally illustrated suspension member according to FIG. 1;

FIG. 3 shows the side view of a hook according to the invention connected to an eye hook which is illustrated partly in section;

FIG. 4 shows the rear view of the hook illustrated in FIG. 3 and the side view of the eye hook connected thereto;

FIG. 5 shows an overview illustrating the wide variety of possible uses of the hook according to the invention.

### METHODS OF IMPLEMENTING THE INVENTION

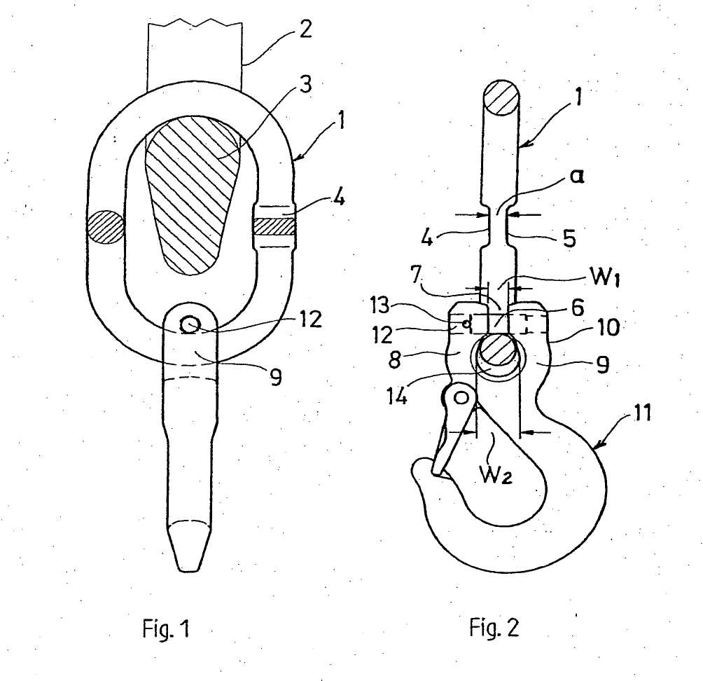

In FIGS. 1 and 2, 1 is a suspension member which has a sufficient spacing and inner width to allow it to be fitted into the tine 2, which is merely indicated in FIG. 1, of a crane hook, of which the cross section 3 largely fills the clear width of the suspension member 1. The suspension member 1 is provided, in a known manner, with two flattened portions 4, 5, the distance a between which is smaller than the width W₁ of the introduction gap 7 which is spanned by a cross-bolt 6 and belongs to a fork head 10, which has two tines 8 and 9 and belongs to a hook 11 designed in accordance with the invention. In the case illustrated, the hook 11 and the suspension member 1 form a unit which can be utilized in order for an eye-containing point of attachment fastened on a load to be connected to a crane hook. In order to secure the suspension member 1 and hook 11 together, use is made of a stepped board 12, which ensures the captive state of the cross-bolt 6, and a clamping pin 13. The width W₂ of the eye 14, which is formed by the cross-bolt 6 and the hook tines 8 and 9, and the inner width of the suspension member 1 make it possible for the latter to move without obstruction in the eye 14 both perpendicularly and parallel to the plane of the drawing.

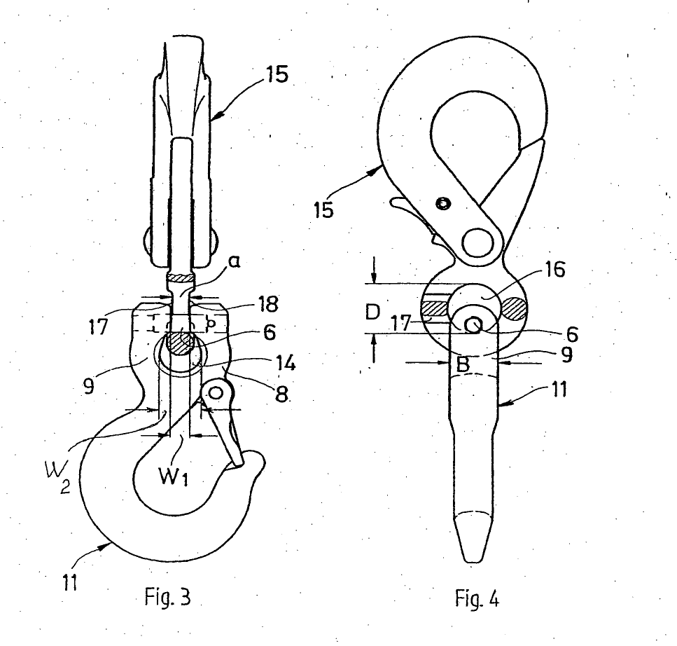

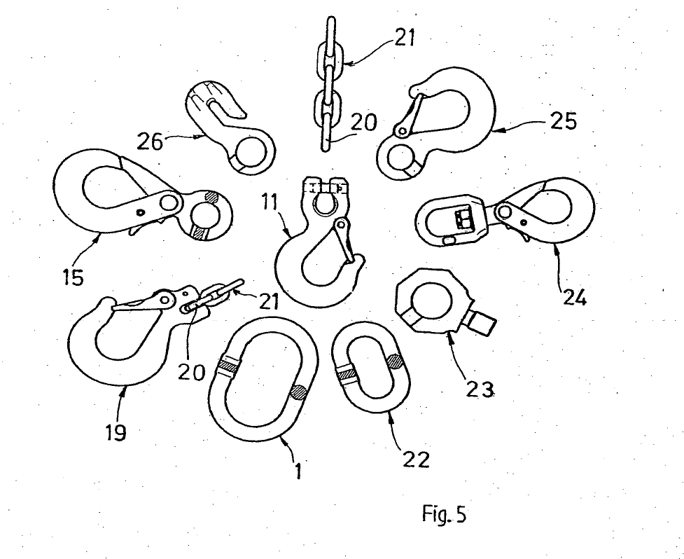

FIGS. 3 and 4 illustrate a unit which is formed from a hook 11 from FIG. 1 according to the invention and by an eye hook 15 and can be utilized, for example, in order to connect the end link of a single-strand ring chain according to DIN 5688 Part 3 to an eye-containing point of attachment. As in the previously described case of the suspension member, in this case the eye hook 15 has, in the region of its eye 16, two flattened portions 17, 18, the distance a between which is smaller than the width W₁ of the introduction gap of the hook 11. On account of the fact that the diameter D of the eye 16 is greater than the width B of the fork tines 8, 9, movements between the hook 11 and the eye hook 15 are possible, once again, both in the plane of the drawing and perpendicularly to the, plane of the drawing.

FIG. 5 documents the wide variety of possible uses of the hook 11 and the fact that, in contrast to the conventional fork-head hook 19 likewise depicted in this figure, it can be connected not just to the end link 20 of a more or less long chain-strand section 21, but also—as has already been explained—to a suspension member 1, an eye hook 11 and, in addition, to a connecting member 22, a point of attachment 23, a swivel hook 24, a modified eye hook and to a shortening element 26. It goes without saying that it is also necessary for the parts 22 to 26, in the coupling region, to have flattened portions which allow them to be introduced into the introduction gap of the fork head of the hook 11.

1. A hook (11) with a fork head (10) which is suitable for connecting a high-strength round steel chain and of which the fork tines (8, 9) bound an introduction gap (7), of which the width is equal to 1.05 to 1.3 times the thickness of the links of the round steel chain and which is spanned by a cross-bolt (6) which serves for transferring loads and is adapted to the inner width of the chain link which is to be connected in each case, characterized in that the fork tines (8, 9) of the hook, together with the cross-bolt (6), form an annular eye (14)+which adjoins the introduction gap (7) and of which the inside width (W₂) is greater than the width (W₁) of the introduction gap (7), the latter width being adapted to flattened zones of components (1; 15; 22; 23; 24; 25; 26) which can be introduced into the fork head.

2. The hook as claimed in claim 1, characterized in that the inside width (W₂) of the eye (14) is at least equal to twice the width (W₁) of the introduction gap (7).

3. The hook as claimed in claim 1, characterized in that the width (B) of the fork tines (8, 9) in the region of the eye (14) is equal to 2.5 to 3.5 times the width (W₁) of the introduction gap (7).

4. The hook as claimed in claim 1, characterized in that the peripheries of both sides of the fork tines (8, 9) which are directed toward one another in the region of the eye (14) are rounded.

5. The hook as claimed in claim 2, characterized in that the width (B) of the fork tines (8, 9) in the region of the eye (14) is equal to 2.5 to 3.5 times the width (W₁) of the introduction gap (7).

6. The hook as claimed in claim 2, characterized in that the peripheries of both sides of the fork tines (8, 9) which are directed toward one another in the region of the eye (14) are rounded.

7. The hook as claimed in claim 3, characterized in that the peripheries of both sides of the fork tines (8, 9) which are directed toward one another in the region of the eye (14) are rounded.

8. The hook as claimed in claim 5, characterized in that the peripheries of both sides of the fork tines (8, 9) which are directed toward one another in the region of the eye (14) are rounded.
